(19) United States
(12) Patent Application Publication
(10) Pub. No.: US 2006/0036838 A1
(43) Pub. Date: Feb. 16, 2006

(54) Security system network interface and security system incorporating the same

(76) Inventors: David M. Salcedo, Lake Worth, FL (US); Gary Mark Shafer, Boca Raton, FL (US); Lawrence M. Speciale, Jacksonville, FL (US); Renrick L. Blackman, Deerfield Beach, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 10/914,899

(22) Filed: Aug. 10, 2004

(51) Int. Cl. G06F 15/177

(52) U.S. Cl. 713/1

(57) ABSTRACT

An interface for coupling one or more security devices to a network. The interface includes a server for loading a network page in a browser; and at least one control module for receiving data from the network page loaded to facilitate communication of the data between the network page the security device(s). A system including a security device and such a network interface is also provided, along with a method of communicating data between a network device coupled to a network and a security device, and a method of providing notification of an alarm condition in a security device.

### TECHNICAL FIELD

The present invention relates to a network interface and, in particular, to a network interface for facillitating communication of data from security devices.

### BACKGROUND

A variety of establishments use security devices for monitoring certain activities or products. The devices may include, for example, video surveillance devices, EAS or RFID systems, metal detectors, etc. In some configurations, the devices are communicatively isolated from each other so that data communication between the devices is not possible. Interfacing with the various devices is performed at a local level, and no external connections are implemented for providing communication with the devices from outside of the establishment in which the devices are installed.

In such configurations, due to the isolation of the devices and the lack of reporting facilities in local interfacing equipment, aggregation of statistical data or analysis of data patterns is not possible. Additionally, logistics problems result from an inability to efficiently detect equipment failures. Once a failure is detected, the equipment is disabled until service personnel arrives, which may be days later.

To address these issues, attempts have been made to interconnect security devices using non-standard connections and protocols. These attempts have been limited to providing data at a centralized location within the establishment and/or by providing inefficient use of resources. For example, one configuration incorporates a server to facilitate interconnection of devices, but requires continuous use of the server. Continuous use of a server is known to provide limited capabilities with large overhead requirements.

Accordingly, there is a need for a security system network that enables facile and efficient communication of data in a security system.

### SUMMARY

According to one aspect of the invention there is provided an interface for coupling at least one security device to a network. The interface includes: a server for loading a network page in a browser associated with a network device coupled to the network; and at least one control module for receiving data from the network page loaded in the browser to facilitate communication of the data between the network page loaded in the browser and the at least one security device. A system including a security device and such a network interface is also provided.

According to another aspect of the invention, there is provided a method of communicating data between a network device coupled to a network and a security device. The method includes: coupling the security device to the network through a network interface, the network interface comprising a server and at least one control module; loading a network page from the server into a browser associated with the network device; and receiving data from the network page into at least one control module for directing the data to the network device.

According to yet another aspect of the invention there is provided a method of providing notification of an alarm condition in a security device. The method includes coupling the security device to an email server; providing a notification to the email server in response to the alarm condition; and transmitting an email from the email server in response to the notification.

### BRIEF DESCRIPTION OF THE DRAWINGS

For a better understanding of the present invention, together with other objects, features and advantages, reference should be made to the following detailed description which should be read in conjunction with the following figures wherein like numerals represent like parts:

FIG. 1 is block diagram of an exemplary security system consistent with the invention including a network interface for connecting security equipment to a network device through a network;

FIG. 2 is a block diagram of an exemplary security system consistent with the invention illustrating components of an exemplary network interface consistent with the invention;

FIG. 3 is a block flow diagram of one exemplary method of communicating data consistent with the invention; and

FIG. 4 is a detailed block diagram of an exemplary security system consistent with the invention illustrating components of an exemplary network interface consistent with the invention.

### DETAILED DESCRIPTION

For simplicity and ease of explanation, the present invention will be described herein in connection with various exemplary embodiments thereof. Those skilled in the art will recognize, however, that the features and advantages of the present invention may be implemented in a variety of configurations. It is to be understood, therefore, that the embodiments described herein are presented by way of illustration, not of limitation.

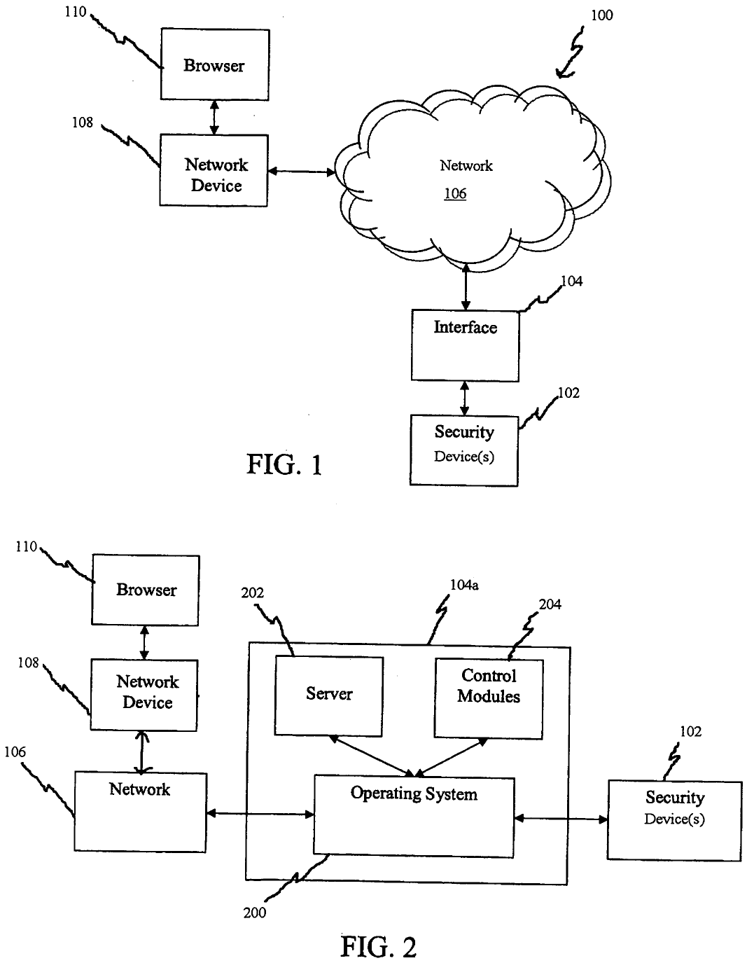

FIG. 1 is a block diagram of a security system 100 consistent with the invention. The system generally includes one or more security devices 102 coupled to a network interface 104. Those skilled in the art will appreciate that communication between various devices, e.g. between the security devices 102 and the network interface 104, may be provided via dedicated cable connections, or through wireless connections. Wireless connections may be established in a variety of ways, such as through communication of electromagnetic signals between antennas, by an infra red link, etc.

The security devices 102 may include any of a variety of well-know devices including, but not limited to, video equipment, EAS or RFID equipment, object recognition equipment, metal detectors, etc. The devices may be fixed or handheld devices, such as a personal-digital-assistant (PDA). As is know to those skilled in the art, the security devices may be installed in a protected area to monitor or provide access to the area for people or products, and/or to collect data regarding people or products.

The network interface 104 couples the security devices 102 for communication with one or more network devices 108 through a communication network 106. The network 106 may take a variety of configurations that are well known in the art. The network may, for example, be a wide-area-network (WAN) or local-area-network (LAN). Those skilled in the art will recognize that a LAN generally interconnects a group of computers in close proximity to each other such as in an office building, a school, or a home, whereas a WAN typically spans a larger geographic area, such as a state, province or country. WANs often connect multiple smaller networks, such as LANs.

For simplicity an ease of explanation, the network 106 will be described herein as including the internet. The term “internet” as used herein refers to the well-known, worldwide computer network that interconnects other computer networks, on which end-user services, such as World Wide Web sites or data archives, are located, enabling data and other information to be exchanged. It is to be understood, however, that a system consistent with the invention is not limit to communication through the internet.

In a manner to be described in greater detail below, the network device 108 may provide a request for connection to a server associated with the interface through the network. A “network device” is a device including a computer, or collection of computers, which is connected to the network 106, and is configured to send requests to such a server. As used herein, a “server” refers to a device including a computer, or a collection of computers, which is connected to a network and is configured to respond to requests directed thereto. In some cases, one computer or collection of computers may act as a network device for one set of requests and as a server for another set of requests.

Several commonly used protocols exist for handling requests from a network device to a server and responses to those requests depending on the nature of the request. For example, the File Transfer Protocol (FTP) is a protocol used by a network device to request a file from a server. Hypertext Transport Protocol (HTTP) is a protocol used by a network device to request a hypertext document, such as a network page, and used by a server to return requested documents as well as to transport server-initiated objects. These protocols typically operate on top of a lower level protocol known as the Transport Control Protocol/Internet Protocol (TCP/IP). Each of these protocols is well known, so they need not be described here in further detail.

The network device 108 may obtain and view hypertext documents using a browser 110. The browser 110 may be provided in a variety of configurations. For instance, the browser may include browser software such as Netscape Navigator™, Microsoft Internet Explorer™ and/or direct real-time Transmission Control Protocol/Internet Protocol (TCP/IP).

The browser 110 may enable Java 2 applets with server side script technology to allow data exchange between the network device 108 and the network interface 104 through the network 106. As is known, the HTTP protocol has evolved from a protocol for transporting static, pre-existing hypertext documents to a protocol which allows for servers to generate hypertext documents on-the-fly based on the nature and parameters of the request, session “state” maintained by a server, and many other varied factors. For example, instead of a request being directed to a static, pre-existing hypertext page stored on a server, the request could be directed to a script, such as a Common Gateway Interface (CGI) script. With such a script, a network device may send the network interface a request that could specify either a network page or a script. The network interface may interpret that the request as directed to a script and respond by executing the script and returning the output of the script.

In an embodiment wherein the network 106 is, for example, the internet or other WAN, a system consistent with the invention facilitates remote access and control of the security devices via the network device 108. Although only one network device 108 is shown, those skilled in the art will appreciate that any number of network devices may be coupled to the network for communication with the security devices. In fact, where the network includes the internet, the security equipment 102 may be accessed or controlled from any of the countless network devices 108 coupled the internet throughout the world.

Turning now to FIG. 2, there is illustrated a block diagram of a system consistent with the invention illustrating an exemplary network interface 104a consistent with the invention. It will be appreciated that the functionality described for the embodiments of the invention may be implemented using hardware, software, or a combination of hardware and software. In the illustrated exemplary embodiment, a network interface 104a may be a microprocessor-based device adapted to execute a set of software modules to provide an interface between the security equipment and a network device through a browser. The network interface may be configured to analyze data and/or pass an analysis task to another device for statistical data processing. The interface may also be configured to provide feedback of failure conditions and preliminary fault analysis of the security devices to facilitate coordination of a service effort.

For simplicity, the processor is not specifically shown in FIG. 2. The processor may, however, be any type of processor capable of providing the speed and functionality required by the embodiments of the invention. For example, the processor may be a processor from the Pentium® family of processors made by Intel Corporation, or the family of processors made by Motorola. Software modules may be stored on a machine-readable media. Machine-readable media includes any media capable of storing instructions adapted to be executed by a processor. Some examples of such media include, but are not limited to, read-only memory (ROM), random-access memory (RAM), programmable ROM (PROM), erasable programmable ROM (EPROM), electronically erasable programmable ROM (EEPROM), dynamic RAM (DRAM), and any other device that can store digital information. The instructions may be stored on the medium in a compressed and/or encrypted format.

In the embodiment illustrated in FIG. 2, the network interface includes an operating system 200, a server 202, and one or more control modules 204. The interface 104a may be assigned an address on the network, e.g. an IP address, and a user may connect a network device 108 to the interface 104a via browser 110 and the network 106 using known protocols. The server 202 operates through the operating system 200 to serve up a network page to the browser 110 for providing a starting point for communication. The control modules 204 establishes a secondary channel of communication supported by the operating system 200 for transferring data between the security devices 102 and the browser 110. Advantageously, this configuration significantly reduces the number of features that need to be supported by the server 202, allowing it to occupy relatively small amount of memory space.

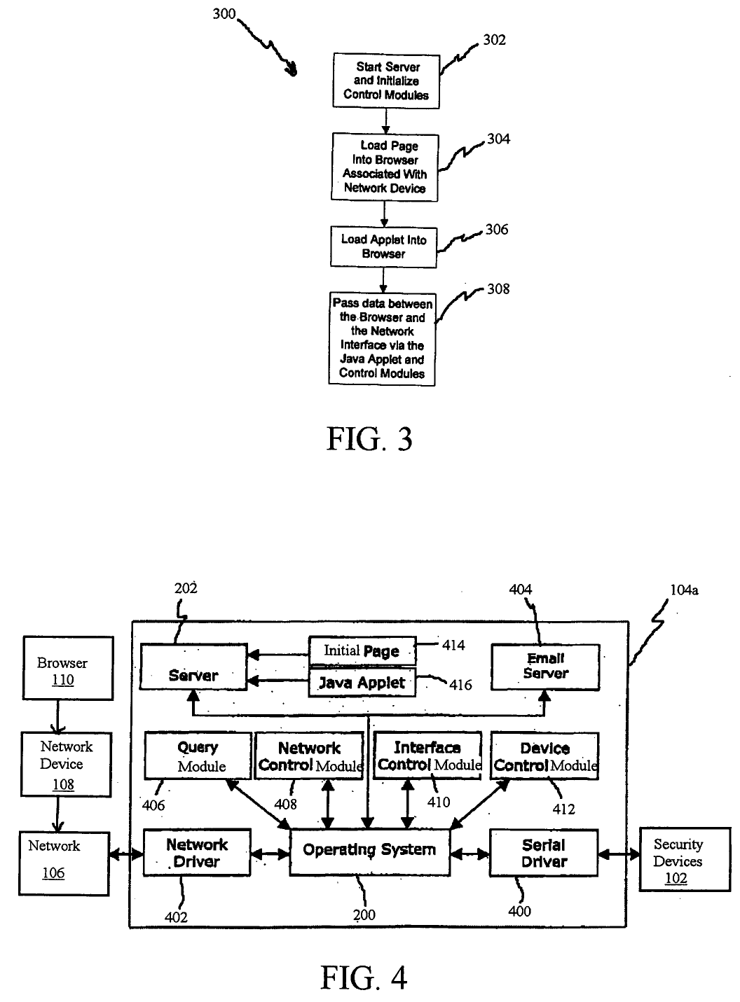

FIG. 3 is a block flow diagram 300 of an exemplary method of operation of system consistent with the invention. The illustrated flow diagram includes a particular sequence of steps. It can be appreciated, however, that the sequence of steps merely provides an example of how the general functionality described herein may be implemented. Further, each sequence of steps does not have to be executed in the order presented unless otherwise indicated.

In step 302, the server is started and the control modules are initialized. Upon a request from a browser associated with a network device, an initial network page is loaded 304 from the server into the browser. The browser requests a Java applet from the server, and the applet is loaded 306 into the browser. Data communication between the browser and the network interface is then achieved 308 via the Java applet and control modules. The server is no longer required to facilitate such communication, thereby conserving memory space.

Those skilled in the art will recognize that a system consistent with the invention may be implemented in a variety of configurations. FIG. 4 is a detailed block diagram of one exemplary embodiment of a network interface 104a consistent with the invention. As shown, the interface 104a includes an operating system 200, a serial driver 400, a network driver 402, a server 202, an email server 404, a query module 406, a network control module 408, an interface control module 410, and a device control module 412. These components are illustrated in FIG. 4 as separate components. Those skilled in the art will recognize, however, that it is possible to incorporate one or more of the components or modules into a single component or module, or divide the associated tasks in a different manner. Also, the interface 104a may be externally coupled to one or more security devices 102 or may be integrated into one or more security devices.

Connection between the interface 104a and the security devices 102 may be established through one or more serial ports and an Ethernet connection. The serial driver 400 (or drivers) and network driver 402 may be provided to establish the hardware interface between the security device(s) 102 and the interface 104a, and between the interface 104a and the network 106, respectively. The serial 400 and network 402 drivers may be provided as separate components or as part of the operating system 200. The operating system 200 may be any operating system known in the art. For instance, operating systems such as Windows® or Linux® systems capable of operating with a Java capable browser may be utilized.

The server 202 may establish a starting point for communication between the security equipment 102 and the network device 108 using an initial network page 414 and a Java applet 416. The initial network page 414 may the form of HTML (Hypertext Markup Language, a subset of the Standard Generalized Markup Language, or “SGML”) tagged text including ActiveX controls. The controls may include well-known buttons, fields, sliders, and other controls.

As will be appreciated by those skilled in the art, the Java applet 416 interacts with the ActiveX controls on the network page. The Java applet also establishes a secondary network connection to the network interface 104a by facilitating communication between interface 104a and the controls on the network page loaded into the browser 110. The server 202 provides the initial network page 414 to the browser 110 and loads a Java applet 416 into the browser 110. In one advantageous embodiment, once the server sets up the initial page 114 and loads the Java applet 416 into the browser, it is not used again until the next time a browser requests attachment to the network interface 104a.

The email server 404 may be configured for providing notification to operators and/or service personnel. For example, when an exception condition arises or an alarm is triggered in a security device, the email server 404 may be configured to send an email message that notifies operators and service personnel of a situation requiring a response. The email server 404 may send messages to multiple recipients, depending upon the requirements of the application.

The interface control module 410 may be configured to receive data coming from either the network 106 or the security devices 102. This module may be customized to handle the data for the particular security device 102 that is attached to the interface 104a. The network control module 408 may be configured to receive data from the interface control module 410, place it into packets and send it out to the network 106. It may also receive packets from the network 106, unbundle data from the packets, and send the data to the interface control module 410. The packets may be taken from and sent to a network device that has requested data from the interface 104a through the query module 406.

The device control module 412 may be configured to receive data from the interface control module 410, format it into a message format associated with a security device 102, and send it out to the device. It may also receive messages from the security devices 102, unbundle the data, and send it to the interface control module 410. The query module 406 may be configured to operate in concert with the interface control module 410 to handle queries from network devices. It may receive a query from the network control module 408, obtain the requested information from a storage area accessible by the interface control module 410, and send the data back to the network control module 408 for dispatching to the requesting network device.

In operation, a security device 102 may be set up and connected serially to the network interface 104a. The network interface 104a may be connected to a network 106, e.g. the internet, through a network cable or through wireless means. The interface 104a may be assigned an address, e.g. an IP address, so devices on the network 106 can identify and connect to the interface 104a in a manner well-known to those skilled in the art.

When the interface 104 is powered, the web and email servers may be started along with the code that runs the four control modules 406, 408, 410 and 412 of the interface 104a. The network control module 408 and query module 406 may wait for communications from the network 106, while the device control module 412 establishes a communication channel with the security devices.

A user may connect to the interface 104 with the network device 108 and the browser 110 using the IP address assigned to the network interface 104a. The server 202 accepts this request and sends the network page 414 to the browser 110. The network device loads the network page 414 into the browser 110 and finds a tag for loading the Java applet 416. The browser 110 makes a request to the server 202 for the Java applet 416. The server 202 sends the Java applet 416 to the browser 110, and the browser runs the applet.

The Java applet 416 sets up links to the ActiveX controls on the browser 110 so the data can be transferred to the control modules, 406, 408, 410 and 412. The Java applet 416 also sets up a separate network channel to communicate with the interface 104a through the network control module 408. This module 408 accepts the connection to establish a separate channel between the browser 110 and the interface 104a.

The applet 416 waits for data to appear at the network on this channel. When the data arrives, the applet 416 directs it to the appropriate ActiveX control. Also, the applet 416 handles events from the controls like button pushes and data entry and sends data packets for controlling the security devices 102 through network 106 and the interface 104a.

At the interface 104a, the network control module 408 extracts data from the packets received from the Java applet 416. The data may be passed to the interface control module 410, which processes it. If the data is intended for controlling or causing activity on the security devices, the interface control module 410 may send the appropriate data to the device control module 412. The device control module 412 packages the data into messages and sends it to the security device(s).

The security devices 102 may absorb the data or may send a response back to the interface 104a for updating the browser controls. If a response is provided, data are passed back through the modules of the interface 104a, out the network port, into the Java program, and finally into the controls on the network page.

If an alarm or exception occurs, the security devices 102 may notify the interface 104a. In response, the interface 104a may format a message and pass it onto the email server 404 as notification to the email server that an alarm has occurred. The email server 404 may be configured to reformat the message so it can be sent out as email. The server 404 may then send the email to one or more predetermined recipients, e.g. to request service for the device.

If a network device sends a request for information about the security devices, the request may be passed to the query module. The query module may determine what information is requested and retrieve the latest values for the information from a storage area maintained by the interface control module. The query module may send this data back to the network device.

There is thus provided a security system including a network interface for providing remote access to security devices through a network connection. The network connection enables remote control and monitoring, and facilitates remote diagnostics and service. Also, the system may operate using standard protocols and a standard browser, although a custom protocol and/or browser may be used. The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. A system comprising:
at least one security device; and
a network interface coupled to said security device, said network interface comprising a server for loading a network page in a browser associated with a network device coupled to said network, and at least one control module for receiving data from said network page loaded in said browser to facilitate communication of said data between said network page loaded in said browser and said at least one security device.

2. The system of claim 1, wherein said security device comprises a device selected from the group consisting of: video equipment, EAS equipment, RFID equipment, object recognition equipment, and a metal detector.

3. The system of claim 1, wherein said at least one security device is coupled to said network interface for serial data communication therewith.

4. The system of claim 1, wherein said network page comprises a HTML page.

5. The system of claim 1, wherein said network comprises a wide area network.

6. The system of claim 1, wherein said network comprises the internet.

7. The system of claim 1, wherein said server is configured to load a Java applet into said browser in response to a Java applet request from said browser.

8. The system of claim 1, said network interface further comprising an email server, said email server being configured for providing an email notification in response to a condition in said at least one security device.

9. The system of claim 8, wherein said email server is configured to provide said notification to at least one predetermined recipient.

10. The system of claim 8, wherein said condition comprises an alarm condition.

11. The system of claim 1, wherein said at least one control module comprises a network control module configured to receive said data and extract said data from associated data packets.

12. The system of claim 11, wherein said at least one control module comprises a interface control module configured to receive said data from said network control module and direct said data to a device control module, said device control module being configured to direct said data to said at least one security device.

13. The system of claim 1, wherein said at least one control module comprises a query control module for receiving a query request from said network device and directing data to said network device in response to said query request.

14. An interface for coupling at least one security device to a network, said interface comprising:
a server for loading a network page in a browser associated with a network device coupled to said network; and
at least one control module for receiving data from said network page loaded in said browser to facilitate communication of said data between said network page loaded in said browser and said at least one security device.

15. The interface of claim 14, wherein said network page comprises a HTML page.

16. The interface of claim 14, wherein said network comprises a wide area network.

17. The interface of claim 14, wherein said network comprises the internet.

18. The interface of claim 14, wherein said server is configured to load a Java applet into said browser in response to a Java applet request from said browser.

19. The interface of claim 14, said network interface further comprising an email server, said email server being configured for providing an email notification in response to a condition in said at least one security device.

20. The interface of claim 19, wherein said email server is configured to provide said notification to at least one predetermined recipient.

21. The interface of claim 19, wherein said condition comprises an alarm condition.

22. The interface of claim 14, wherein said at least one control module comprises a network control module configured to receive said data and extract said data from associated data packets.

23. The interface of claim 22, wherein said at least one control module comprises a interface control module configured to receive said data from said network control module and direct said data to a device control module, said device control module being configured to direct said data to said at least one security device.

24. The interface of claim 14, wherein said at least one control module comprises a query control module for receiving a query request from said network device and directing data to said network device in response to said query request.

25. A method of communicating data between a network device coupled to a network and a security device, said method comprising:
coupling said security device to said network through a network interface, said network interface comprising a server and at least one control module;
loading a network page from said server into a browser associated with said network device; and
receiving data from said network page into said at least one control module for directing said data to said network device.

26. The method of claim 25, wherein said security device comprises a device selected from the group consisting of: video equipment, EAS equipment, RFID equipment, object recognition equipment, and a metal detector.

27. The method of claim 25, wherein said at least one security device is coupled to said network interface for serial data communication therewith.

28. The method of claim 25, wherein said network page comprises a HTML page.

29. The method of claim 25, wherein said network comprises a wide area network.

30. The method of claim 25, wherein said network comprises the internet.

31. The method of claim 25, said method further comprising loading a Java applet into said browser in response to Java applet request from said browser.

32. The method of claim 25, wherein said at least one control module comprises a network control module configured to receive said data and extract said data from associated data packets.

33. The method of claim 32, wherein said at least one control module comprises a interface control module configured to receive said data from said network control module and direct said data to a device control module, said device control module being configured to direct said data to said at least one security device.

34. The method of claim 25, wherein said at least one control module comprises a query control module for receiving a query request from said network device and directing data to said network device in response to said query request.

35. A method of providing notification of an alarm condition in a security device, said method comprising:
coupling said security device to an email server;
providing a notification to said email server in response to said alarm condition; and
transmitting an email from said email server in response to said notification.

36. The method of claim 35, wherein said email is transmitted to at least one predetermined recipient.

37. The method of claim 35, wherein said email server is disposed in network interface configured to couple said security device for communication with a network device coupled to a network.

38. The method of claim 38, wherein said network interface comprises:
a server for loading a network page in a browser associated with said network device; and
at least one control module for receiving data from said network page loaded in said browser to facilitate communication of said data between said network page loaded in said browser and said security device.

39. The method of claim 38, wherein said network page comprises a HTML page.

40. The method of claim 37, wherein said network comprises a wide area network.

41. The method of claim 37, wherein said network comprises the internet.
